(19) United States
(12) Patent Application Publication
(10) Pub. No.: US 2026/0263850 A1
(43) Pub. Date: Sep. 10, 2026

(54) PORTABLE STORAGE FOR BATTERY FIRE SUPPRESSION

(71) Applicant: GFI Co.,Ltd, Gyeonggi-do (KR)

(72) Inventors: Sang Sup Lee, Seoul (KR); A Ram Jeon, Seoul (KR)

(73) Assignee: -, (omitted)

(21) Appl. No.: 19/220,031

(22) Filed: May 27, 2025

(30) Foreign Application Priority Data
Mar. 7, 2025 (KR) 10-2025-0030006

(51) Int. Cl. A62C 3/16; A62C 2/06; G08B 17/06

(52) U.S. Cl. CPC A62C 3/16; A62C 2/06; G08B 17/06

(57) ABSTRACT

In a portable storage for battery fire suppression, the portable storage for battery fire suppression according to the present invention comprises an outer casing, a flame-retardant part, a vapor-permeable part, an opening/closing part, a slide fastener, a barrier flap, a storage part, an extinguishing part, an inner lining, a storage space, a sensor unit, a sensor, a power source, and a lamp.

### CROSS-REFERENCE TO RELATED APPLICATION

This application claims priority of Korean Patent Application No. 10-2025-0030006, filed on Mar. 7, 2025, in the KIPO (Korean Intellectual Property Office), the disclosure of which is incorporated herein entirely by reference.

### BACKGROUND OF THE INVENTION

### Field of the Invention

The present invention relates to a portable storage for battery fire suppression, and more particularly, to an invention designed to suppress a fire after introducing an electronic device therein upon detection of precursors to a fire or during the initial stage of a fire involving batteries, including lithium-ion batteries, and the electronic device

### Description of the Related Art

With the recent development of electronic devices, various electronic devices such as mobile phones, tablets, and laptops have become widespread among modern people. These electronic devices generally include lithium-ion batteries that are built-in or attached to the main body. However, these lithium-ion batteries are vulnerable to high temperatures and impacts, leading to a significant increase in cases of fire causing casualties and property damage.

Particularly in recent years, cases of carrying such electronic devices and batteries aboard aircraft for reasons such as business trips and travel have become frequent, and consequently, the occurrence of fires within aircraft has emerged as a significant problem.

The number of aircraft fire incidents accounts for about 0.003% of the approximately 400,000 fires that occurred over the last 10 years. While the percentage in terms of overall fire statistics is small, it is difficult to adequately respond to fires caused by such battery ignition within an aircraft, resulting in the highest average damage cost among fire incidents.

Therefore, there is a pressing need for a device that can immediately react and perform initial fire suppression during the early stages of a battery fire to minimize property damage and loss of life.

Meanwhile, Korean Utility Model Application No. 20-2022-0002961 describes technology related to such battery fire suppression.

### SUMMARY OF THE INVENTION

An object of the present invention is to provide a portable storage for battery fire suppression, which can immediately react upon observing signs of impending fire or during the initial stage of ignition. The battery that has caught fire is placed into the portable storage, a fire extinguishing agent is sprayed inside the storage to block the inflow of external oxygen, discharge the heat, moisture, and oxygen generated internally, thereby reducing internal oxygen to create a sealing effect. The invention allows for the replacement of the used fire extinguishing agent.

The objects of the present invention are not limited to the aforementioned objects, and other objects not mentioned will be clearly understood by those skilled in the art from the following description.

To solve the above problems, the portable storage for battery fire suppression according to the present invention comprises an outer casing, a flame-retardant part, a vapor-permeable part, an opening/closing part, a slide fastener, a barrier flap, a storage part, an extinguishing part, an inner lining, a storage space, a sensor unit, a sensor, and a power source.

An object of the present invention is to provide a portable storage for battery fire suppression, which can immediately react upon observing signs of impending fire or during the initial stage of ignition. The battery that has caught fire is placed into the portable storage, a fire extinguishing agent is sprayed inside the storage to block the inflow of external oxygen, discharge the heat, moisture, and oxygen generated internally, thereby reducing internal oxygen to create a sealing effect. The invention allows for the replacement of the used fire extinguishing agent.

The objects of the present invention are not limited to the aforementioned objects, and other objects not mentioned will be clearly understood by those skilled in the art from the following description.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 is a perspective view illustrating the shape of a portable storage for battery fire suppression according to an embodiment of the present invention.

FIG. 2 is an internal perspective view for explaining the shape of the portable storage for battery fire suppression according to an embodiment of the present invention.

FIG. 3 is a perspective view for explaining the shape of the opening/closing part of the portable storage for battery fire suppression according to an embodiment of the present invention.

FIG. 4 is a diagram illustrating the state of use of the fire extinguishing agent in the portable storage for battery fire suppression according to an embodiment of the present invention.

FIG. 5 is a cross-sectional view for explaining the storage part and the sensor unit of the portable storage for battery fire suppression according to an embodiment of the present invention.

FIG. 6 is a perspective view for explaining an example of use of the portable storage for battery fire suppression according to an embodiment of the present invention.

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Reference herein to a layer formed “on” a substrate or other layer refers to a layer formed directly on top of the substrate or other layer or to an intermediate layer or intermediate layers formed on the substrate or other layer. It will also be understood by those skilled in the art that structures or shapes that are “adjacent” to other structures or shapes may have portions that overlap or are disposed below the adjacent features.

In this specification, the relative terms, such as “below”, “above”, “upper”, “lower”, “horizontal”, and “vertical”, may be used to describe the relationship of one component, layer, or region to another component, layer, or region, as shown in the accompanying drawings. It is to be understood that these terms are intended to encompass not only the directions indicated in the figures, but also the other directions of the elements.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

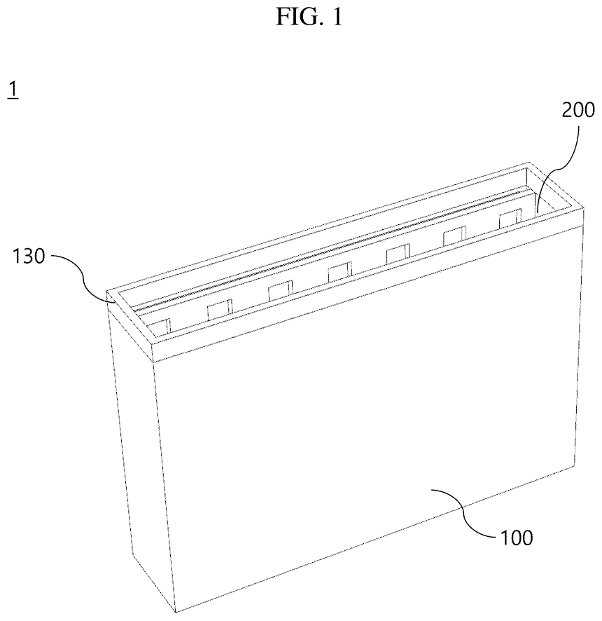

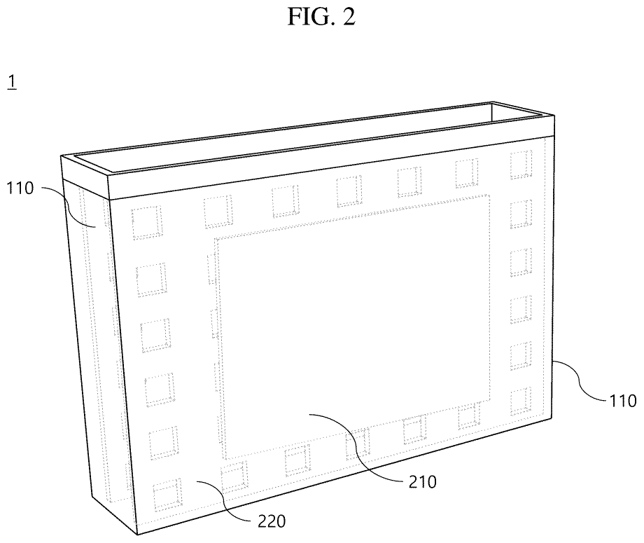

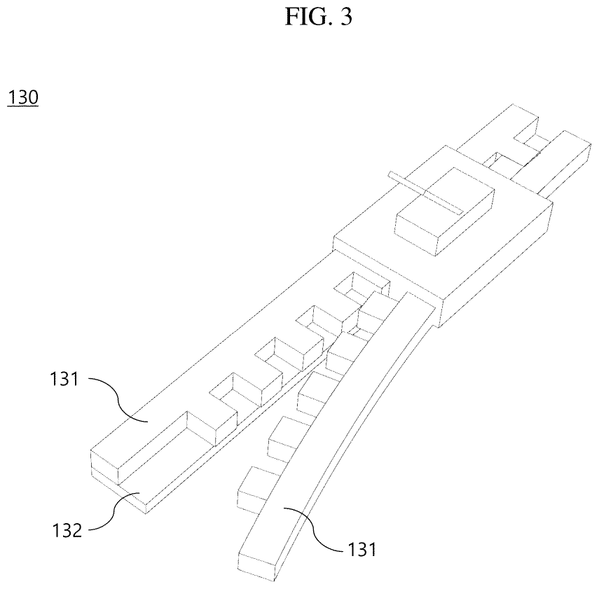

Referring to FIG. 1 to FIG. 6, an embodiment of the present invention relates to a portable storage 1 for battery fire suppression, comprising an outer casing 100, a flame-retardant part 110, a vapor-permeable part 120, an opening/closing part 130, a slide fastener 131, a barrier flap 132, a storage part 200, an extinguishing part 210, an inner lining 220, a storage space 230, a sensor unit 300, a sensor 310, a power source 320, and a lamp.

The portable storage 1 for battery fire suppression includes the outer casing 100 and the storage part 200.

The outer casing 100 includes the flame-retardant part 110, the vapor-permeable part 120, and the opening/closing part 130.

The flame-retardant part 110 can be made of materials such as fabric, textile, silicone material, leather, fur, stainless steel SUS304, SUS303, aluminum, metal materials, etc. It can also be made of various blends such as general cotton material coated with flame-retardant components, plastics, PBI para-aramid, meta-aramid, and anti-static fibers. By utilizing oxidized fiber blended aramid, silicone, or aramid fiber coated with flame-retardant components, it can be used even at temperatures of 1600° C. or higher. The flame-retardant part 110 is located on the front and rear surfaces of the portable storage.

The vapor-permeable part 120 is coupled to and located with the flame-retardant part 110. In an embodiment of the present invention, it is coupled to the flame-retardant part 110 on the left or right side surface of the portable storage. In this case, the vapor-permeable part 120 discharges heat, moisture, and oxygen through the spaces between fibers but prevents external oxygen from flowing in, thereby reducing internal oxygen and providing a sealing effect.

The vapor-permeable part 120 has heat resistance and flame retardancy in a form combined with materials such as PTFE, and vapor permeability for discharging heat, moisture, and oxygen to the outside.

The opening/closing part 130 is located at the upper end of the flame-retardant part 110 and the vapor-permeable part 120.

The opening/closing part 130 includes a slide fastener 131 and a barrier flap 132. The slide fastener 131 is made of a corrosion-resistant metal or plastic material, and the pull tab of the slide fastener 131 are made of a heat-resistant material. The barrier flap 132 is located below the slide fastener 131 and blocks the supply of external oxygen to the inside.

The storage part 200 is formed by the combination of the flame-retardant part 110, the vapor-permeable part 120, and the opening/closing part 130.

The storage part 200 includes the extinguishing part 210, the inner lining 220, and the storage space 230. The extinguishing part 210 has one end surface attached or installed to the inner surface of the flame-retardant part 110.

In an embodiment of the present invention, the extinguishing part 210 is manufactured in a pouch form and attached to one end surface of the flame-retardant part 110 via an adhesive.

The extinguishing part 210 can be attached only to one inner surface of the flame-retardant part 110 located on the front of the portable storage, or it can be attached to the inner surfaces of the flame-retardant parts 110 on both the front and rear sides of the portable storage. The fire extinguishing agent contained in the extinguishing part 210 may be a solid aerosol composed of KNO3, etc., FK-5-1-12, a product utilizing encapsulation of halogen-based compounds, or sodium chloride powder, sodium carbonate powder, lithium chloride powder, copper powder, graphite powder, dry sand, glass powder, expanded vermiculite powder, dolomite powder, zirconium silicate powder, etc.

In a preferred embodiment of the present invention, a solid aerosol composed of KNO3, etc., FK-5-1-12, a capsule-type fire extinguishing agent utilizing encapsulation of halogen-based compounds is introduced into the pouch, or a fire extinguishing agent in the form of sodium chloride powder, sodium carbonate powder, lithium chloride powder, copper powder, graphite powder, dry sand, glass powder, expanded vermiculite powder, dolomite powder, and zirconium silicate powder is introduced, or a liquid-type fire extinguishing agent is introduced for use.

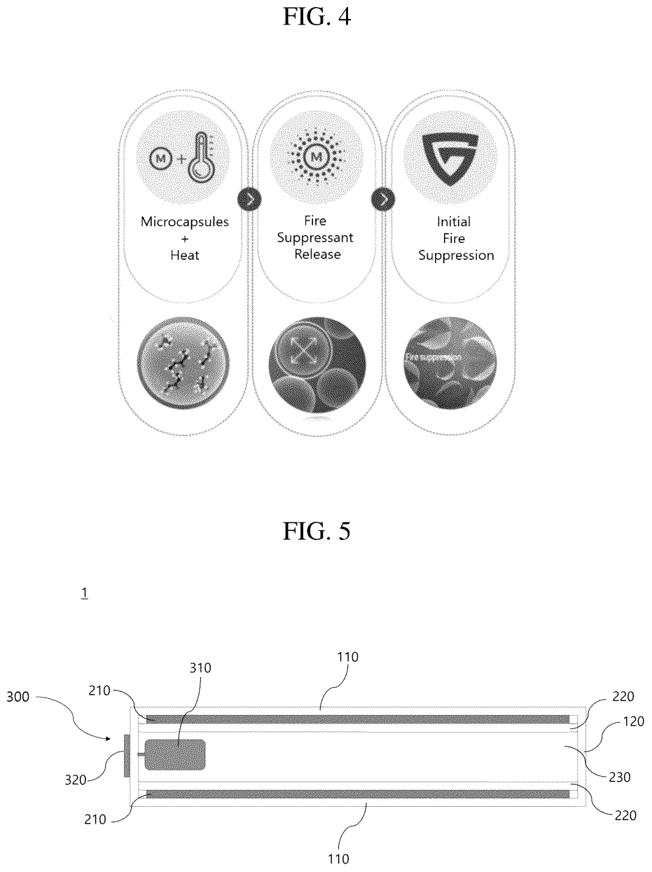

In an embodiment of the present invention, as confirmed in FIG. 4, when the temperature inside the portable storage rises due to the temperature of the ignited battery introduced into the portable storage for battery fire suppression, the capsule-type fire extinguishing agent simultaneously expands and vaporizes due to the temperature and is sprayed from the pouch. At this time, the inside of the storage part 200 experiences a decrease in internal temperature due to the fire extinguishing agent and exhibits the effect of discharging internal oxygen to the outside.

The inner lining 220 is coupled so as to separate the extinguishing part 210 and the storage space 230. One end surface of the inner lining 220 is positioned to contact the other end surface of the extinguishing part 210. The lower end of the inner lining 220 is fixedly coupled to the bottom surface part of the outer casing 100, and both side surfaces of the inner lining 220 are fixedly coupled to the side surface parts of the outer casing 100.

The storage space 230 is created on the other end surface side of the inner lining 220, forming sufficient space to accommodate a portable battery or electronic device.

At this time, the sewing thread used for coupling the flame-retardant part 110 and the vapor-permeable part 120, or the flame-retardant part 110 and the opening/closing part 130 of the portable storage for battery fire suppression in the preferred embodiment of the present invention is an aramid fiber, and the tear strength is 10N or more on average.

In an embodiment of the present invention, the inner lining 220 is in a mesh form with multiple perforations, allowing the fire extinguishing agent inside the extinguishing part 210 to be sprayed evenly onto the ignited battery when it expands and sprays. Furthermore, the inner lining 220 forms a space between the fire extinguishing agent and the ignited battery, which can also be expected to have the effect of preventing the fire extinguishing agent from clumping in a specific area.

Since the upper end of the inner lining 220 is not coupled to the opening/closing part 130, the used extinguishing part 210 can be replaced through the opened upper opening/closing part 130 when the slide fastener 131 of the opening/closing part 130 is opened.

As confirmed in FIG. 5, the portable storage 1 for battery fire suppression includes a sensor unit 300, and the sensor unit 300 includes a sensor 310 and a power source 320. In this case, the sensor 310 is placed inside the internal space and connected by wire to the power source 320 installed on the outer surface of the outer casing 100. The wire used here is a flame-retardant wire, fire-resistant wire, heat-resistant wire, etc., enabling use even in a fire situation. The sensor 310 is characterized by transmitting a fire alarm to the user's receiver when the internal temperature is detected to be 140° C. or higher.

In another embodiment of the present invention, the sensor 310 can be used as a passive sensor. The passive sensor can be a sensor using a thermoelectric element that reacts to the heat generated inside, a bimetallic sensor, a piezoelectric sensor, etc. The passive sensor is placed inside the internal space and connected by wire to a lamp installed on the outer surface of the outer casing 100. The wire used here is a flame-retardant wire, fire-resistant wire, heat-resistant wire, etc., enabling use even in a fire situation. In this embodiment of the present invention, after detecting the internal heat through the passive sensor, if the sensor detects that the internal temperature has deviated from the normal range, the lamp installed on the outer casing generates a signal to warn of a fire occurrence.

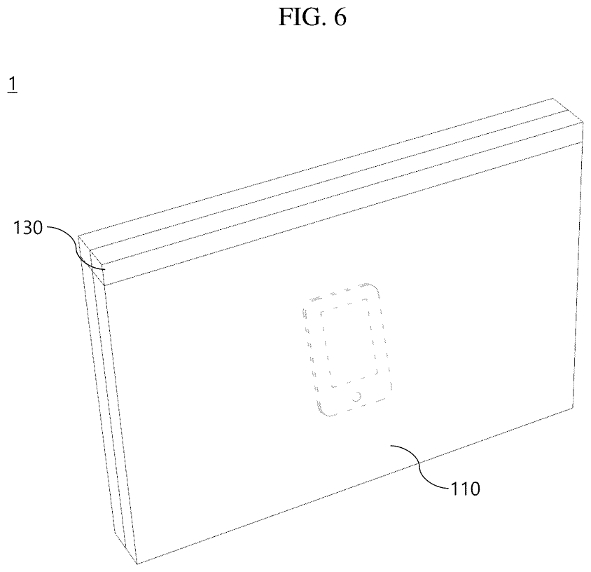

according to an embodiment of the present invention can be used portably in aircraft, trains, cars, subways, etc. To explain in more detail, when using the portable storage for battery fire suppression, if a user or discoverer recognizes that a portable battery or electronic device is overheating or has ignited, they introduce the battery or electronic device into the portable storage in the manner shown in FIG. 6 and then close the opening/closing part 130. Subsequently, the supply of external oxygen is blocked through the slide fastener 131 and the barrier flap 132 of the opening/closing part 130 to prevent the spread of fire. The fire extinguishing agent from the extinguishing part 210 suppresses the fire of the electronic device or battery inside the portable storage. The vapor-permeable part 120 blocks the inflow of external oxygen during the fire suppression process and discharges the heat, moisture, and oxygen generated internally, thereby reducing internal oxygen and providing a sealing effect.

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims

The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A portable storage for battery fire suppression, comprising:
an outer casing, the outer casing comprising:
a flame-retardant part located on front and rear surfaces of the portable storage;
a vapor-permeable part positioned to be coupled with the flame-retardant part; and
an opening/closing part located at an upper end of the flame-retardant part and the vapor-permeable part; and
a storage part comprising:
an extinguishing part having one end surface attached or installed to an inner surface of the flame-retardant part;
an inner lining having one end surface positioned to contact another end surface of the extinguishing part, wherein a lower end of the inner lining is fixedly coupled to a bottom surface part of the outer casing, wherein both side surfaces of the inner lining are fixedly coupled to side surface parts of the outer casing; and
a storage space formed on another end surface side of the inner lining,
wherein the storage part is formed by coupling the flame-retardant part, the vapor-permeable part, and the opening/closing part.

2. The portable storage for battery fire suppression of claim 1, wherein the opening/closing part comprises:
a slide fastener made of a corrosion-resistant metal or plastic material;
a pull tab of the slide fastener made of a heat-resistant material; and
a barrier flap located below the slide fastener.

3. The portable storage for battery fire suppression of claim 1, wherein the vapor-permeable part is made of a material capable of discharging internal heat and moisture to the outside.

4. The portable storage for battery fire suppression of claim 1,
wherein the portable storage for battery fire suppression comprises a sensor unit,
wherein the sensor unit comprises a sensor and a power source,
wherein the sensor is disposed inside the storage space,
the power source is disposed on an outer surface of the outer casing,
wherein the sensor and the power source are connected by a wire,
wherein the wire is one of flame-retardant wire, fire-resistant wire, and heat-resistant wire,
wherein the sensor transmits an alarm when an internal temperature is detected to be 140° C. or higher.

5. The portable storage for battery fire suppression of claim 1,
wherein the extinguishing part contains a fire extinguishing agent,
wherein the extinguishing part is attachable by an adhesive,
wherein the extinguishing part is replaceable through the opened opening/closing part when the fire extinguishing agent is depleted.

6. The portable storage for battery fire suppression of claim 1, wherein the vapor-permeable part has a structure that discharges heat and moisture but prevents external oxygen from flowing in.

7. The portable storage for battery fire suppression of claim 1,
wherein the vapor-permeable part is formed on left and right side surfaces of the portable storage,
wherein the flame-retardant part and the vapor-permeable part are coupled through sewing.

8. The portable storage for battery fire suppression of claim 1,
wherein the extinguishing part contains a fire extinguishing agent,
wherein the inner lining separates the extinguishing part and the internal space,
wherein the inner lining is formed with a plurality of perforations to allow the fire extinguishing agent from the extinguishing part to be discharged.

9. The portable storage for battery fire suppression of claim 1,
wherein the portable storage for battery fire suppression comprises a sensor unit,
wherein the sensor unit comprises a passive sensor and a lamp,
wherein the sensor is disposed inside the storage space,
wherein the lamp is disposed on an outer surface of the outer casing,
wherein the sensor and the lamp are connected by a wire,
wherein the wire is one of flame-retardant wire, fire-resistant wire, and heat-resistant wire,
wherein the sensor transmits a signal to the lamp when an internal temperature is detected to be 140° C. or higher,
wherein the lamp operates upon receiving the signal.
